(19) United States
(12) Patent Application Publication
(10) Pub. No.: US 2010/0279627 A1
(43) Pub. Date: Nov. 4, 2010

(54) SYSTEM FOR LIMITING MOBILE DEVICE FUNCTIONALITY IN DESIGNATED ENVIRONMENTS

(75) Inventor: FRANK BRADLEY, BOULDER, CO (US)

Correspondence Address: MARSH, FISCHMANN & BREYFOGLE LLP, 8055 East Tufts Avenue, Suite 450, Denver, CO, 80237, US

(73) Assignee: BOULDER CELLULAR LABS, INC., BOULDER, CO (US)

(21) Appl. No.: 12/701,846

(22) Filed: Feb. 8, 2010

Related U.S. Application Data
(60) Provisional application No. 61/173,865, filed on Apr. 29, 2009.
(60) Provisional application No. 61/179,868, filed on May 20, 2009.

(51) Int. Cl. H04B 7/005

(52) U.S. Cl. 455/69

(57) ABSTRACT

Apparatuses, systems and methods for limiting mobile device functionality in defined environments. One system includes a detection arrangement for detecting illicit mobile device RF transmissions and/or an operating state in relation to a defined environment, and a disabling arrangement for at least partially disabling the functionality of the mobile device upon detection of an illicit mobile device RF transmission or a particular operating state. For instance, the system may be implemented in an automobile or aircraft cabin to prevent drivers and/or passengers from utilizing at least one functionality of a mobile device (e.g., talking, texting, interne surfing).

### CROSS-REFERENCE TO RELATED APPLICATIONS

This application claims the benefit of U.S. Provisional Application No. 61/179,868, entitled, “SYSTEM FOR LIMITING MOBILE DEVICE FUNCTIONALITY IN DESIGNATED ENVIRONMENTS,” filed on May 20, 2009 and U.S. Provisional Application No. 61/173,865, entitled, “SYSTEM FOR LIMITING MOBILE DEVICE FUNCTIONALITY IN DESIGNATED ENVIRONMENTS,” filed on Apr. 29, 2009. The disclosure of the above-mentioned related applications is hereby incorporated into the present application.

### BACKGROUND OF THE INVENTION

Mobile device usage has grown dramatically over the past decade and is generally ubiquitous in today's society. These devices fulfill the needs of many people to have instant access to information and to communicate with anyone almost anywhere in the world. Although mobile device usage was initially restricted to businesspeople and the affluent, it now has spread to almost all segments of the population (e.g., the elderly, schoolchildren, teenagers, families). While mobile devices have increased the availability of and speed of access to information, mobile device usage can create many well recognized life-threatening hazards.

In recent years, concern has grown regarding the problem of mobile device use while operating a motor vehicle. In particular, many have recognized that the attention required to find and dial a phone and/or carry on a conversation on the phone (with or without a hands-free option) while driving is different from other kinds of potential distractions, such as listening to a radio or carrying on an in-person conversation. More specifically, mobile device use by a motor vehicle driver and/or that is heard by a motor vehicle driver is significantly more distracting than other types of activities. For instance, a driver may be distracted by hearing one end of a conversation being had by a passenger, and moreover, may become even more distracted when the passenger hands the mobile device to the driver so that the driver can engage in the conversation as well. As the functionality of mobile devices has increased to include text messaging and internet access, for instance, this problem has become more pronounced. In the United States, a number of jurisdictions have enacted or are considering legislation to limit or prohibit mobile device use, or types of use, by drivers. These activities reflect the significant safety issue that has been recognized in this regard.

It may also be desired to restrict mobile device use in other environments, e.g., by operators of mass transit vehicles, by patients or visitors in a medical facility or inmates in a prison. The potential hazards associated with mobile device transmissions in other environments are well known. For example, some mobile device manufacturers provide “airplane mode” operation which can disable wireless features (e.g., those that emit RF transmissions) of the device. However, avoiding these transmissions remains dependent on passengers' cooperation and vigilance in turning devices off or placing the devices in airplane mode.

### SUMMARY OF THE INVENTION

It has been discovered that many people, environments and scenarios would benefit from systems, apparatuses and methods that can detect (e.g., automatically) whether one or more mobile devices are being operated (e.g., is transmitting/receiving RF signals in the context of voice, text and/or internet communications) and/or whether a machine (e.g., vehicle, automobile, aircraft, boat) is being operated, and thereafter selectively control such mobile devices (e.g., disabling, altering or interfering with the functionality of such mobile devices). For instance, as motor vehicle drivers may be less distracted because of the systems, apparatuses and methods disclosed herein, such drivers may be more likely to see an oncoming truck that has crossed a double-yellow line or a stopped car ahead. As an additional example, restricting airline passengers from transmitting signals with cells phones may reduce interference with aircraft operation and other electrical equipment and thus increase aircraft safety.

The present invention is directed to methods, apparatuses and systems for limiting mobile device (e.g., cellular telephones, PDAs, mobile data devices, laptop computers) functionality in defined situations or settings (“environments”) such as, for example, during driving, on aircraft/in-flight, or in prisons (e.g., prison blocks). That is, the system may prevent mobile device use altogether in such environments, may restrict usage to only receiving transmissions, may restrict the type or duration of transmissions, may limit the functions (voice, text, data, network management communications) or numbers/recipients (e.g., 911 calls) that are allowed or disallowed, and/or may otherwise interfere with use of the mobile device.

In accordance with one aspect of the present invention, a system is provided for limiting mobile device usage in one or more defined environments such as but not limited to, vehicles, aircraft, prisons, etc. The system includes detection structure (e.g., a detection arrangement) for detecting at least one of a condition related to presence of the mobile device in a defined environment and/or a condition related to an operating state associated with the one or more defined environments, and interference structure (e.g., a disabling arrangement) for selectively inhibiting (e.g., interfering with) or allowing use of the mobile device in response to the detected condition. In one embodiment, the detection structure may include any appropriate componentry (e.g., a transmission detector including an antenna and associated processor to process received signals) that may locate RF signals being emitted by one or more mobile devices which may indicate the existence of an improper or illicit use of such devices. For instance, the componentry may include at least one band-pass filter that is operable to pass the transmissions through a demodulator. The detector may be permanently installed in an automobile or other vehicle (e.g., in a hard to reach location) or in any other location wherein detection of mobile device usage is desired (e.g., prison cell blocks). In other variations, the detector may be a compact and/or hand-held device.

In another aspect, a motor vehicle is provided that includes a first structure for sensing an operating state of the motor vehicle or a condition related to the presence of a mobile device in said motor vehicle, and a second structure for at least partially disabling operation of a mobile device based on the sensed operating state or condition.

In another aspect, a motor vehicle is provided that includes a first structure for sensing an operating state of the motor vehicle and a second structure for at least partially acoustically interfering with use of one or more mobile devices based on the sensed operating state.

In another aspect, a mobile device controller is provided for use in reducing mobile device usage while driving includes a first structure, in communication with the motor vehicle, for sensing an operating state of the motor vehicle or a condition related to the presence of a mobile device in the motor vehicle, and a second structure, in communication with the mobile device, for selectively disabling, at least in part, operation of said mobile device responsive to the sensed operating state or condition of the motor vehicle.

In another aspect, a method is provided for use in reducing mobile device functionality in one or more defined environments may include detecting (e.g., using the detection structure disclosed herein) at least one of a condition related to an operating state associated with the one or more define environments and the presence of one or more mobile devices in the one or more defined environments and, in response to the detected condition, interfering with (e.g., using the interference structure disclosed herein) the operation of the one or more mobile devices in the one or more defined environments.

In another aspect, a method is provided for use in reducing mobile device functionality in defined environments includes detecting (e.g., using the detection structure disclosed herein) a condition related to the presence of a mobile device in a defined environment or an operating state associated with the defined environment, and in response to the detected condition, controlling (e.g., using the interference structure disclosed herein) the operation of said mobile device in the defined environment to selectively enable or disable at least one functionality of said mobile device.

In another aspect, a method is provided for use in controlling use of a mobile device in defined environments includes providing a transmission detector for detecting transmissions of interest with respect to a defined environment, operating the detector so as to detect a first transmission of interest from a mobile device within the defined environment, and upon detecting the first transmission of interest, taking corrective action to terminate further transmissions from the mobile device within the defined environment.

In another aspect, a method is provided for use in controlling use of one or more mobile devices in defined environments includes determining, with a first detection device, that one or more mobile devices are transmitting or receiving RF signals in a defined environment, and locating, with a second detection device, the one or more mobile devices. For instance, a mobile device disabling unit may be associated near or at a location of said one or more mobile devices, and the location may be at least one of a prison block and a prison cell. As another example, corrective action may be taken after the locating to terminate further transmissions from the one or more mobile devices within the defined environment.

In some variations of the aspects, it may be desired to only limit mobile device usage with respect to devices in the driver's area and not throughout the passenger compartment. This may be accomplished by sensing a location of one or more mobile devices using location signal detectors located near the driver's seat or any other appropriate mechanism. Alternatively, mobile devices in the driver's area may be sensed by a number of antennas located near a perimeter of the driver's area. For instance, antennas could be located near corners of the driver's seat and adjacent portions of the vehicle in front of the driver.

In addition or alternative to the above methods and devices for detecting a condition related to presence of the mobile device in a defined environment, the mobile device of a driver and/or others may be selectively disabled or enabled based on an operating state associated with the defined area (e.g., of a vehicle). In this regard, public safety and enforcement of relevant regulations may be improved. Moreover, the problem of drivers borrowing a phone to circumvent controlling measures may be avoided. In the case of a motor vehicle, the operating state of the vehicle may be detected in a variety of ways. For example, it may be desired to inhibit mobile device usage when the vehicle is turned on. This may be accomplished by using detection structure in the form of any appropriate circuitry to detect an ignition switch signal or a signal associated with operation of the vehicle motor. Any other signal that indicates the operating state of the motor vehicle may be utilized. For example, the system may generate a dedicated signal such as a radio signal when the vehicle is turned on. Such a signal could be recognized by a cooperating mobile device with embedded logic for disabling, at least in part, mobile device usage while the signal continues. Alternatively, the detected operating state may relate to a transmission setting. In this regard, it may be desired to allow mobile device usage when the vehicle is not in motion. Accordingly, the system may sense when the vehicle is in park or, perhaps, in the case of manual transmissions, in neutral and/or when the parking brake is engaged.

In other arrangements, a detected operating state of the vehicle may trigger the need to limit mobile device functionality. For instance, the detected operating state may relate to any appropriate velocity or speed sensor and/or an operation of a motor or engine. Additionally or alternatively, the detected condition may relate to any electromagnetic radiation emitted by the vehicle.

As another example and in the case of monitoring improper mobile device use in an airplane cabin, a flight attendant or other official could operate a transmission detector to detect any improper transmission after instructions have been provided to turn off mobile devices. Optionally, the detector may be equipped to locate an offending mobile device in the event that announcements have not succeeded in eliminating the improper transmissions, e.g., the detector may have a variable threshold so as to enable progressive narrowing of the mobile device location or may provide signal strength readings to assist in homing in one and locating the mobile device (e.g., by a flight attendant or other personnel). In this manner, improper transmission can be identified and addressed even where the mobile devices do not have specialized circuitry, e.g., prior to any regulatory requirement for such circuitry and in cases where passengers have older equipment or are from different jurisdictions subject to different regulatory regions.

As noted above, the system includes selectively inhibiting (e.g., interfering with) or enabling use of the mobile device, at least in part, in response to the detected condition using any appropriate interference structure. This selective inhibiting or enabling may be performed automatically in response to the detected condition or else may prompt a user or other operator to manually inhibit or enable use of the mobile device. In this regard, it may be desirable to at least partially disable incoming and/or outgoing transmissions of the mobile device, or else allow reception of incoming calls but to limit or disable outgoing transmissions. As an example and in the case of restricting mobile device use by vehicle drivers, this may allow a caller to transmit messages to the driver or passengers while preventing conversation with attendant distraction to the driver. Also in this regard, the driver may be allowed to speak briefly, a short recorded message may be transmitted to the caller indicating that the call recipient is driving and cannot immediately respond, and/or the caller may be forwarded to the call recipient's voicemail.

In one embodiment, the interference structure may include any appropriate circuitry and/or other componentry that may be incorporated into or at least partially resident within the mobile device and/or accessories for disabling transmissions when desired. For example, logic may be incorporated into the mobile device to disallow operation of the mobile device RF transceiver in a transmission mode. It may be desired to allow certain exceptions in this regard such as transmission of 911 calls, transmissions associated with network overhead (e.g., polling signals and location transmissions) or other transmissions deemed benign or allowed by applicable laws and regulations. Alternatively, circuitry for disabling, at least in part, the mobile device may be incorporated into a cradle, docking station or other structure external to the phone. As a still further alternative, circuitry may be incorporated into the motor vehicle. For example, the mobile device may be configured to require an electrical or other communication connection to the motor vehicle in order to enable operation. Such a signal or communication from the motor vehicle could be terminated to inhibit mobile device use during driving. As a still further alternative, the motor vehicle may include a signal transmitter for interfering with transmissions by the mobile device from the motor vehicle cabin.

The interference structure may include any appropriate componentry, structure and/or logic for acoustically interfering with operation of an offending mobile device. For instance, conversation may be inhibited by operating a sound generating device to generate sounds (e.g., white noise, human speech) that may jam or otherwise interfere with conversation from the motor vehicle cabin. Such a system could deter drivers from circumventing the system by borrowing or using another phone in the vehicle. The sound generating device could be mounted or placed in a hard to reach physical location (e.g., by a vehicle manufacturer) to prevent intentional disablement of the sound generating device. The sound may include a sound level peak higher than a sound level peak of transmissions associated with the one or more mobile devices. The interference structure may also include a scrambling device operable to generate scrambling transmissions. For example, the scrambling transmissions may operate at frequencies similar to frequencies used by transmissions associated with the one or more mobile devices.

The presence of any of the detection and/or interference structures disclosed herein may be checked and/or confirmed by any appropriate personnel. For instance, the structures may be checked during routing vehicle inspections or at violation stops (e.g., in relation to speeding tickets, running red lights) by attempting use of a mobile device in the defined environment (e.g., in the vehicle cabin).

In the case of limiting mobile device use in aircraft, a pilot, flight attendant, FAA official or other personnel may cause a signal to be transmitted when use limitations are appropriate (e.g., during a “restricted use” period). Alternatively, such a signal may be generated automatically during appropriate phases of a flight. Any appropriate signal (e.g., frequency and/or code) could be used in this regard. For instance, the signal may be transmitted over the cellular frequency band as other frequencies may require different transmitters which may be disabled without affecting cellular band operation. The mobile devices may be constructed to turn off, go to sleep or go into airplane mode in response to this signal. A separate signal may be provided to re-enable full functionality. Alternatively, the first signal may extend continuously or periodically throughout the time period where use restrictions are in place. The mobile device may then resume full functionality, manually or automatically. Though such a system, involving specialized circuits to control phone operation on aircraft or other defined environments, is desirable in that the control process is substantially automated, it may be useful to monitor user compliance as an additional or alternative measure.

### BRIEF DESCRIPTION OF THE DRAWINGS

FIG. 1 illustrates a mobile device that may be usable as part of the systems and methods disclosed herein.

FIG. 2A illustrates a block diagram of one embodiment of a system for limiting mobile device functionality in designated environments.

FIG. 2B illustrates a block diagram of a defined area and a mobile device.

FIG. 3 illustrates a block diagram of one embodiment of a detection arrangement that may be used as part of the system of FIG. 2A.

FIG. 4 illustrates a schematic diagram of an automobile including a mobile device functionality limiting system according to one embodiment.

FIG. 5 illustrates a schematic diagram of an aircraft including a mobile device functionality limiting system according to one embodiment.

FIG. 6 illustrates a schematic diagram of a prison including a mobile device functionality limiting system according to one embodiment.

FIG. 7 illustrates a method of use of the system of any of the embodiments described herein.

### DETAILED DESCRIPTION

Reference will now be made to the accompanying drawings, which assist in illustrating the various pertinent features of the present invention. Although the invention will now be discussed in conjunction with vehicle, aircraft and prison environments, it should be expressly understood that the invention is also applicable to the detection of mobile device use and/or an operating condition of a particular device or environment and subsequent disablement or enablement of a mobile device in other environments. In this regard, the following description of systems and methods for limiting mobile device functionality in designated environments is presented for purposes of illustration and is not intended to limit the invention to the form or applications disclosed herein. Consequently, variations and modifications consummate with the following teachings, and skill and knowledge of the relevant art, are within the scope of the present invention.

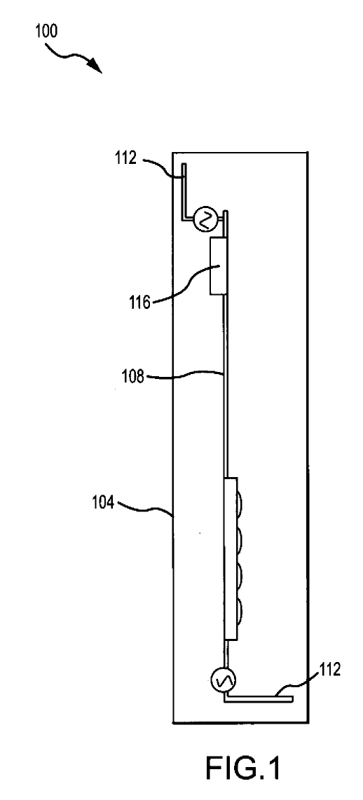

FIG. 1 illustrates a block diagram of a mobile device 100 (e.g., cellular phone, PDA, laptop) that may be usable with any of the embodiments described herein. The mobile device may include an outer housing 104, an internal structure 108 (e.g., circuit board(s)), one or more antennas 112, one or more speakers and microphones (not shown), a display (not shown) and one or more input devices which may be in the form of a keyboard, a touch screen arrangement, and the like (not shown). While also not illustrated, the mobile device 100 may include a bus, a processor, a memory, a read only memory (ROM), and a storage device, all of which may be incorporated with the internal structure 108.

The mobile device 100 may also include one or more transceiver devices 116 or other similar devices of any appropriate type that are operable to enable the mobile device 100 to communicate via a network. For instance, the transceiver device 116 may be any device that produces and/or transmits radio frequency (RF) signals, receives RF signals, and/or both transmits and receives RF signals. Moreover, the transceiver device may operate in conjunction with a modem and/or an Ethernet interface for communicating via any appropriate network (e.g., a local area network).

It should be appreciated that other similar electronic block diagrams of the same or alternate type can be utilized for the phone 100 to handle various requirements of mobile device 100. The mobile device 100 may perform functions in response to the processor by executing sequences of instructions contained in a computer-readable medium, such as, for example, memory, a magnetic disk, or an optical disk. Such instructions may be read into memory from another computer-readable medium, such as storage device, or from a separate device via a communication interface.

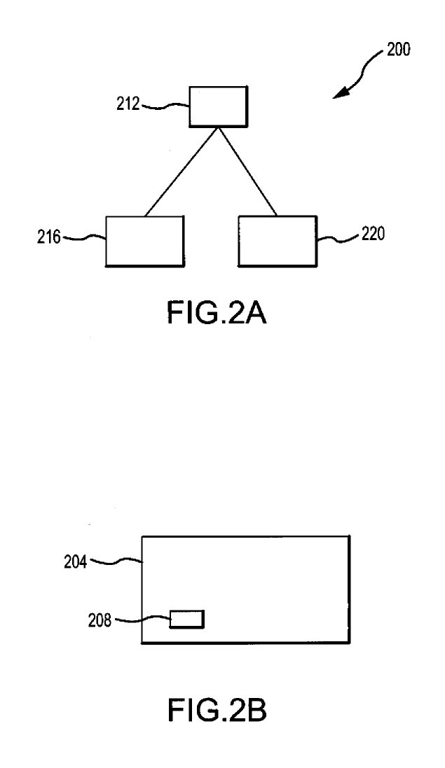

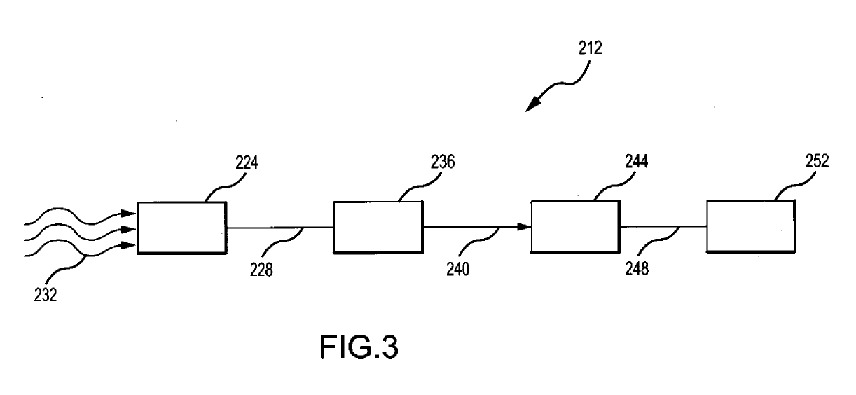

Referring now to FIGS. 2A and 2B, block diagrams of one embodiment of a system 200 for limiting mobile device functionality and a defined area 204 (e.g., designated environment) within which it may be desired to limit mobile device functionality are illustrated. Generally, the system 200 may include a detection arrangement 212, a disabling arrangement 216, and/or a notification arrangement 220, although it will be appreciated that the system 200 may include more or fewer than all of the above elements and/or components. Furthermore, although the detection arrangement 212, disabling arrangement 216, and notification arrangement 220 (broadly referred to herein as “main elements”) are illustrated as being separate elements, other arrangements are also contemplated. For instance, two or more of the main elements may be included within or as part of the same device, structure and/or software, and the main elements may be in communication by any appropriate network (e.g., wired, wireless) and/or other connection mechanisms. As shown in FIG. 2B, the system 200 may define a defined area 204 within which it is desired that one or more mobile devices 208 (e.g., the above-described mobile device 100) be at least partially disabled upon particular conditions being detected by the detection arrangement 212 of FIG. 2A. It should be appreciated that one or more of the main elements may be disposed within the defined area 204 and/or the mobile device 208.

The defined area 204 may include any area, region, territory, and the like where it is desired that the functionality of one or more mobile devices be altered or at least partially disabled or enabled. The defined area 204 may be in the form of any shape or size, and need not be a homogenous area, e.g., the defined area 204 may be in the form two or more sub-areas that are at least partially separated by an area in which it is not desired to at least partially alter or disable mobile device functionality. For instance, the defined area 204 may be the entire interior space of an automobile or only a portion of the interior space of an automobile (e.g., an area surrounding and encompassing the driver). As another example, the defined area 204 may be the passenger cabin of an aircraft such that one or more mobile devices within the passenger cabin may be detected and/or altered as will be more fully described below.

The detection arrangement 212 may include one or more pieces of hardware and/or software that may be located in any appropriate location and associated with any appropriate device that may assist in detecting or otherwise sensing the existence of one or more situations or scenarios. In one arrangement, the detection arrangement 212 may be in the form of one or more detection devices (e.g., one or more appropriate antennas and associated processors to process received signals) that are operable to detect whether a mobile device 208 is in a particular range (e.g., in the defined area). For instance, the detection arrangement 212 may be operable to detect any transmissions of interest (e.g., RF signals that operate on those frequencies used by mobile devices as part of voice and/or interne communication, text messaging). The detection arrangement 212 may be a permanently located device (e.g., in an automobile or a prison cell block) or may itself be a mobile device that may be used to progressively home in on one or more mobile device 208 transmitting signals. A detection area of the detection device may be adjusted by controlling the directivity of the detection device (e.g., radius of its detection field) and placement of the detection device (e.g., singular, arrayed).

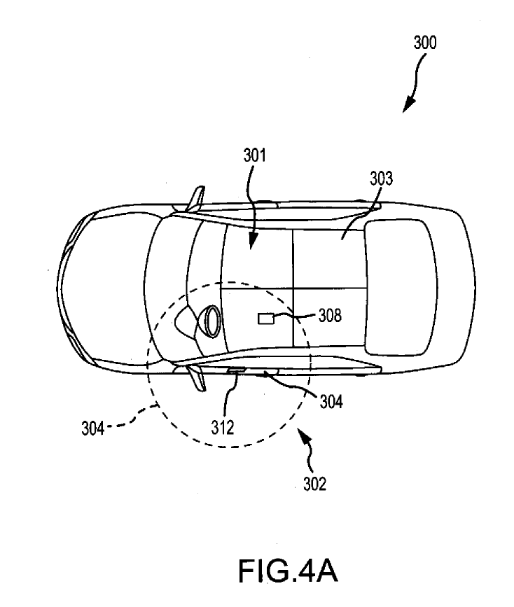

With reference to FIG. 3, a block diagram of one embodiment of a detection arrangement 212 is illustrated. It should be appreciated that the detection arrangement 212 may be located within a self-contained housing or else may form componentry within the housing of another device (e.g., the below-described “acoustical jammer”). As illustrated, the detection arrangement 212 may include any appropriate band-pass filter 224 that may be set to pass signals at frequencies within a certain range (e.g., passes RF signals 228 used in mobile device transmission) and rejects (e.g., attenuates) other signals 232 at frequencies outside that range. The passed RF signals 228 may be sent through a demodulator 236 to appropriately extract an original information bearing signal 240 (e.g., the voice traffic from a mobile device 208) from the passed RF signal 228 (e.g., modulated carrier wave). The signal 240 may be sent to any appropriate DC generating device 244, and the generated DC voltage 248 may be used to power any appropriate notification mechanism such as a silent alarm 252.

Additionally or alternatively, any RF signals passed through the band-pass filter or other arrangement may be operable to appropriately trigger a disabling arrangement (e.g., disabling arrangement 216) that may be associated with the detection arrangement 212 (e.g., in the same housing). As will be described below, the disabling arrangement 216 may be operable to emit tones or sounds and/or scramble the detected RF signals. In any case, it will be appreciated that as the magnitude of the DC voltage 248 may vary with the strength of the passed RF signals 228, the strength of the alarm output may also correspondingly vary. Thus, a louder alarm output may indicate a stronger passed RF signal 228 and thus closer usage of one or more mobile devices 208. Although not illustrated, the detection arrangement 212 may include any appropriate switches or other devices to adjust a signal detection level of the band-pass filter 224. Thus, the detection arrangement 212 may be appropriately set to detect usage of one or more mobile devices 208 in prisons, airplanes, and the like.

Referring back to FIGS. 2A and 2B, the detection arrangement 212 may in another arrangement be in the form of one or more detection devices that are operable to detect an operating state in relation to or associated with the defined area 204. In this regard, the operating state may be separate from and generally not dependent upon a mobile device 208 being present or not within the defined area 204. For instance, the detection arrangement 212 may be in the form of a sensor or transducer in any appropriate place that is operable to detect an electrical signal such as ignition voltage, an engine speed, a transmission position (e.g., drive v. park), electromagnetic radiation, a manual signal by personnel (e.g., a flight attendant flipping a “disable cell phones” switch), and the like. As another example, the detection arrangement 212 may be a circuit, wire and/or cable that transmits an ignition voltage directly to the disabling and/or notification arrangements 216, 220 to enable operation of the disabling and/or notification arrangements 216, 220. In another arrangement, the detection arrangement 212 may be in the form of the above-discussed hardware and/or software operable to detect any transmissions of interest, and this hardware and/or software may be enabled by a detected operating state associated with the defined area 204.

In any case and upon the detection arrangement 212 detecting a mobile device 208 being in the defined area 204 and/or an operating state in relation to the defined area 204 having changed, the disabling/enabling arrangement 216 (hereinafter “disabling arrangement”) may be operable or otherwise enabled to selectively disable or enable, at least in part, one or more mobile devices 208 (e.g., the disabling arrangement 216 may be “triggered”). This selective inhibiting or enabling may be performed automatically in response to the detected condition or else may prompt a user or other operator to manually inhibit or enable use of the mobile device 208. In this regard, the ability to send and receive RF transmissions to and from or otherwise use the mobile device 208 may be disabled in full or in part. As will be appreciated below, the disabling arrangement 216 may include any combination of hardware, componentry, wired and wireless networks, software (e.g., logic), and the like that may function alone or in any combination to cause the functionality of one or more mobile device 208 to be altered or otherwise enabled or disabled.

In one arrangement, the disabling arrangement 216 may be in the form of any appropriate acoustical scrambling or jamming device that may be operable to interfere with and at least partially prevent sensible communication (e.g., audio, text, internet). The scrambling device may include any appropriate number and type of antennas, circuitry and power supplies that may be able to generate and transmit RF signals at any appropriate frequencies (e.g. similar or equal to those frequencies that mobile devices send and receive signals with) to interfere with those frequencies used by the mobile device 208 to send and/or receive RF signals. The scrambling device may overpower the mobile device 208 by transmitting a signal on the same frequency and at a high enough power that the two signals collide and substantially cancel each other out (e.g., corrupt signals used by the mobile device 208). As some mobile devices 208 may be designed to add power if low-level interference is experienced, the scrambling device may recognize and substantially match the power increase from the mobile device 208. The scrambling device may be resident within the mobile device 208, within a portion of the defined area 204 (e.g., within a vehicle cabin), and the like. For instance, the scrambling device may be included in a mobile device either during manufacture or as an after-market component.

In another arrangement, the disabling arrangement 216 may be any appropriate device operable to emit sounds or tones (e.g., a sound transmitter) that would make using a mobile device 208 (e.g., talking, texting, internet surfing) overly difficult and cause the user to cease using the mobile device 208. For instance, the disabling arrangement 216 may emit a continuous, loud beeping sound (e.g., similar to a seatbelt chime when a seatbelt is not fastened) that would not stop until RF transmissions associated with the mobile device 208 are not detected in the defined area 204 and the operating state is not longer detected (see discussion of the detection arrangement 212 above). In one variation, the disabling arrangement 216 may generate a combination of white noise and speech-like sounds that may be added to voice traffic or other data transmission of the mobile device 208. For instance, the white noise and/or speech-like traffic may include a higher sound level peak (e.g., a few dB) than the voice traffic with which it competes and/or may be denser in character than the voice traffic. In some embodiments, the speech-like sounds need not bear any relation to the voice traffic it is meant to obscure. Other types of sounds, flashing lights, and the like are also contemplated. In the case of the detection arrangement 212 including a sensor that detects an ignition voltage of an automobile, the ignition voltage may be connected to a circuit installed in the automobile that is in communication with the disabling arrangement 216 to create an interference signal or a sound or tones to interfere with someone using the mobile device 208 upon an ignition voltage being sensed.

In a further arrangement, the disabling arrangement 216 may be any appropriate combination of hardware and/or software operable to directly control operation of the mobile device 208. For instance, any appropriate circuitry and/or other componentry may be incorporated into or at least partially resident within a housing of the mobile device 208 for allowing control of the mobile device. In one arrangement, a semiconductor circuit (e.g., a cutoff circuit) may be included in the RF signal transmission path of the mobile device 208 that may be operable to block transmission of RF signals. For example, in the case of the detection arrangement 212 including a sensor that detects an ignition voltage of an automobile, the ignition voltage may send an enabling signal to any appropriate circuit installed in the automobile that in turn may send a wireless signal to the cutoff circuit in the mobile device 208 to disable at least the transmission function of the mobile device 208. Thus, in the absence of an ignition voltage (e.g., when car is turned off), the circuit within the mobile device 208 will pass transmission signals and the mobile device 208 will be otherwise operational. Any appropriate logic may be incorporated into the mobile device 208 to assist in disallowing operation of the RF transceiver of the mobile device 208 in a transmission mode. For example, by appropriately initiating or selecting, for instance, “driving mode” or “airplane mode” (e.g., either automatically in response to a detected condition or manually) in any appropriate manner (e.g., wired, wirelessly), the logic may function to enable the cutoff circuit to prevent transmissions. In other arrangements, the disabling arrangement 216 may be in the form of hardware and/or software (e.g., logic) that may be operable to receive a signal or other communication from the detection arrangement 212 and thereafter limit the phone numbers that can be dialed or texted to only emergency numbers (e.g., 911, police department, towing service, AAA), limit the mobile device 208 to only receiving RF signals instead of transmitting RF signals, etc.

For instance, the disabling arrangement 216 may limit the mobile device 208 to only receiving RF signals, and may either allow the user to enter a message (e.g., voice, text) into the mobile device during a brief open transmission period and/or cause the generation of a hardware and/or software-generated message such as “I cannot talk now because I am driving.” In another scenario, an attempted communication (e.g., call, text) with a mobile device 208 that has one or more functionalities disabled (e.g., because the detection arrangement 212 has detected a particular condition) will cause the disabling arrangement 212 or logic and a processor associated with the mobile device 208 or another server to send a message (e.g., voice, text) back to the initiator of the communication alerting the initiator that the receiver cannot talk (e.g., because the receiver is driving or flying), requesting a return phone number, and/or promising to communicate (e.g., call, text) with the initiator at the next break (e.g., when the automobile is not in operation). In one variation, the mobile device 208 may be equipped with an “arming switch” that, when activated, may prevent RF transmission from the mobile device 208 and cause the recording of messages (e.g., voice mail, text) that can be accessed upon the arming switch being deactivated. Such a feature may be useful in crowded lobbies, during interviews and sales pitches, and the like.

Additionally or alternatively, circuitry and/or other componentry for disabling at least in part may be incorporated into a cradle, docking station or other structure external to the mobile device 208. For instance, a portable plug-in unit for in-car use may include a cutoff circuit and/or an external wire associated with the plug-in unit may be routed through the cutoff circuit resident in the mobile device 208. Moreover, if the plug-in unit or mobile device connector includes a pin for battery voltage input, then the mobile device 208 may have a direct tie-in to the ignition voltage and thus the ignition voltage may directly communicate with a cutoff circuit resident in the mobile device 208 when the mobile device 208 is docked in the plug-in unit or other device.

As a still further alternative, circuitry may be incorporated into the motor vehicle. For example, the mobile device 208 may be configured to require an electrical or other communication connection to the motor vehicle in order to enable operation. Such a signal or communication from the motor vehicle could be appropriately terminated to inhibit mobile device use during driving. As a still further alternative, the motor vehicle may include a signal transmitter for interfering with transmissions by the mobile device from the motor vehicle cabin.

It will be appreciated that in some instances, it may be desirable that the disabling arrangement 216 be triggered only when the detection arrangement 212 detects both the predefined operating condition associated with the defined area 204 and illicit mobile device use in the defined area 204, or when only one of detection of a predefined operating condition and illicit mobile phone use is detected. For instance, although a driver might be operating a mobile device (e.g., transmitting RF signals) within a defined area, the disabling arrangement 216 may not be triggered unless the predefined operating state is also detected. However, in other circumstances, it may be desired that even though the operating condition has not been detected (e.g., the automobile is not turned on or is in park), the disabling arrangement 216 still be triggered because, for instance, it may be considered dangerous to talk on a cell phone on an interstate highway, regardless of whether the vehicle is moving or not. In some arrangements, the detected operating state (e.g., ignition voltage, transmission setting) may enable (e.g., ready) any of the discussed disabling arrangements 216 while any detected signals (e.g., voice frequencies, other electromagnetic signals in the range of cell phone transmission frequencies) may activate the disabling arrangement 216 (e.g., cause the transmission of jamming frequencies or direct control of the one or more mobile devices 208).

The notification arrangement 220 may include any appropriate combination of hardware, software, and the like that may be operable to produce a notification for and/or send a notification to any appropriate authorities or personnel that illicit mobile device use has been detected via the detection arrangement 212. For instance, the notification arrangement 220 may include a server or other computing device that may be operable to send a message (e.g., email, text, voice) over any appropriate wired or wireless network to appropriate personnel and/or produce a silent or audible alarm for such personnel regarding any illicit mobile device use.

As previously discussed, some of the above discussed elements or components may be contained in the same housing or otherwise directly associated with each other while in other situations some of the above elements or components may be separately disposed from other elements or components. For instance, the detection arrangement 212 and disabling arrangement 216 may form an acoustic jamming device (“acoustic jammer”) that both detects operating frequencies of one or more mobile devices 208 and/or an operating state of a vehicle, and thereafter interferes with outgoing RF signals emanating from the mobile device 208 (e.g., using an above-described scrambling device) and/or otherwise interferes with it to prevent sensible audio communication (e.g., using the above-described device that emanates a loud, beeping sound). In this regard, the acoustic jammer could be embodied in a single unit and could be conveniently mounted to define any desired defined area 204 (e.g., in an inaccessible location in an automobile or prison cell). Moreover, as no change in cell phone protocol or design would be needed to allow functioning of the acoustic jammer, the acoustic jammer may work in conjunction with almost all mobile devices in existence today. As another example and as described above, the disabling arrangement 216 may be in the form of a blocking circuit that may be contained within the mobile device 208 and in this regard, the disabling arrangement 216 and mobile device 208 may be embodied within a single unit.

Furthermore, at least some of the elements or components described above may be in communication via any appropriate network, circuitry and the like. For instance, the detection arrangement 212 may be in the form of a sensor or transducer appropriately mounted within an automobile transmission to determine whether the automobile is in “Park” or “Drive”, and may appropriately communicate (e.g., wired, wirelessly) such information to a cutoff or blocking circuit in the mobile device 208 and/or to any appropriate device to generate an interference signal, the device being situated within the mobile device 208, somewhere else within the defined area 204, outside the defined area 204, etc. In some scenarios, it may be desired that one or more of the above-noted disabling arrangements 216 not be operational (e.g., the disabling arrangements 216 do not disable functionality of one or more mobile devices 208) for a period of time (e.g., a brief delay) after the detection arrangement 212 has detected a particular condition or scenario. For instance, the mobile device 208 may include any appropriate logic that is operable to determine whether, even in spite of the detection arrangement 212 having detected a particular condition, the user is attempting to communicate with an emergency number (e.g., 911) or perform some other “transmission exception” (e.g., transmissions associated with network overhead such as polling signals and location transmissions, other transmissions deemed benign or allowed by applicable laws and regulations). In response to an affirmative answer, the logic may cause a processor within the mobile device 208 or other location (e.g., server associated with mobile device provider) to suspend operation of one or more disabling arrangements 216 until such transmission exception has passed.

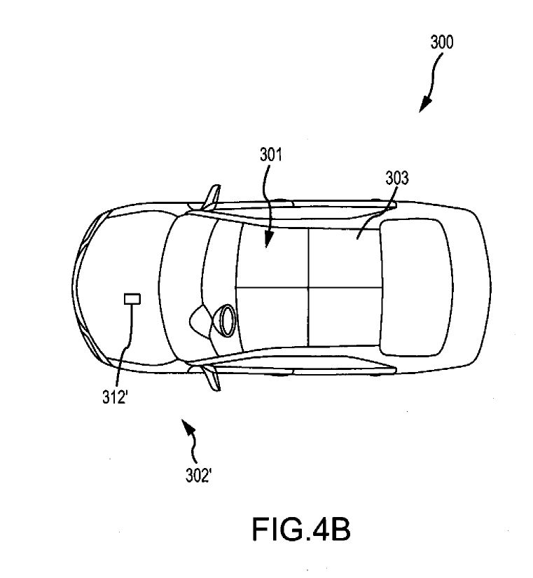

FIG. 4A illustrates a schematic diagram of a motor vehicle or automobile 300 including a mobile device functionality limiting system 302 according to one embodiment. The automobile 300 generally includes a cabin 301 with a number of seating areas 303 (e.g., four, five) and the system 302 for limiting functionality of one or more mobile devices 308 in one or more of the seating areas 303. As illustrated, the system 302 may include a determent device 312 (e.g., includes a housing having a detection arrangement 212 and a disabling arrangement 216 appropriately disposed therein such as the above described acoustic jammer) which may form a defined area 304 within which mobile device 308 usage may be at least partially disabled.

The determent device 312 may include a detection arrangement in the form of any appropriate number of antennas and associated processors to process received signals (e.g., RF signals) to detect whether there is usage of one or more mobile devices 308 in the defined area 304 (e.g., high energy bursts being sent from the mobile device 308). The radius or size of the defined area 304 may be adjusted as previously noted to encompass one or more of the seating areas 303. As shown, the defined area 304 primarily only encompasses a single seating area 303 (e.g., the driver's seat) although in other arrangements the defined area 304 may be designed to encompass additional or other seating areas 303 or other areas. While in some instances the defined area 304 might encompass small portions of the other seating areas 303 not intended to be encompassed by the defined area 304, these portions may likely be negligible and otherwise not substantially affect a user using a mobile device 308 in one of such other seating areas 303.

The determent device 312 may also include a disabling arrangement in the form of any appropriate number of antennas, circuitry and power supplies to generate and transmit RF signals at substantially those frequencies used by mobile devices to interfere with and/or cancel out those used by the mobile device 308 to transmit information and/or those used to receive information. For instance, the disabling arrangement of the determent device 312 may be operable to only affect those frequencies within the defined area 304 and conversely not substantially affect those frequencies outside of the defined area 304. Additionally or alternatively and in the situation where the mobile device 308 has been equipped with a disabling device (e.g., the above described “cutoff circuit”), the determent device 312 may include componentry (e.g., transceiver) to send a signal to the mobile device 308 that allows the cutoff circuit to at least substantially prevent the transmission of RF signals from the mobile device 308. In other embodiments, the determent device 312 may include a disabling arrangement that emits sounds or tones (e.g., a sound transmitter) that renders use of the mobile device 308 overly difficult and causes the user to cease using the mobile device 308.

In one arrangement, the driver may have access to a switch that is in appropriate communication with the determent device 312 or other device that can disable mobile device 308 usage for users in one or more other seating areas 303. For instance, while mobile device 308 usage in the driver's seating area 303 may always at least partially inhibited while the vehicle is being operated and/or while the driver is utilizing a mobile device 308, the driver or other user may be able to selectively disable other mobile devices 308 in other seating areas 303 upon moving the switch. This feature may be useful if other mobile device 308 usage is distracting to the driver. For example, upon requesting silence to no avail, the driver may be able to flip the switch to broadcast a jamming signal that would inhibit usage of other mobile devices 308 in the automobile 308.

As illustrated, the determent device 312 may be mounted or otherwise attached to a portion of the driver's door 313 such as a substantially inaccessible inside portion of the driver's door 313. The determent device 312 may also be located in other portions of the automobile 300 to allow the defined area 304 to include other seating areas 303 and portions of the automobile 300 (e.g., trunk, flatbed). The determent device 312 may also be associated with any appropriate safety device that, when the determent device 312 is moved from its originally located position in the automobile or otherwise tampered with, causes another portion of the automobile (e.g., engine) to become inoperable.

While the determent device 312 has been discussed in the embodiments of FIG. 4A as being a single device or in other words one or more components in a single housing, the embodiments are not so limited. For instance, the determent device 312 may be in the form of a detecting arrangement including one or more antennas appropriately located to define a particular defined area 304 (e.g., located near the driver's seating area) and a separately located disabling arrangement (e.g., located in a substantially inaccessible portion of the engine). In another arrangement, the disabling arrangement may be resident within the mobile device 308. For instance, the mobile device 308 may be shielded such that other mobile devices (not shown) in the automobile may not be affected by the disabling arrangement.

FIG. 4B presents another embodiment of a mobile device functionality limiting system 302′ that may be used in place of the system 302 of FIG. 4A. Corresponding components between the embodiments are identified by common reference numerals. Those corresponding components that differ in at least some respect from the embodiment of FIG. 4A are identified by a “single prime” designation in FIG. 4B. Similar to the system 302, the one or more components of the system 302′ may be of any appropriate size, shape, configuration and/or type. A difference between the system 302 of FIG. 4A and the system 302′ of FIG. 4B is the use of a determent device 312′ that may be operable to detect any appropriate operating state of the vehicle 300 and thereafter cause at least partial disablement of the mobile device 308 as will be described below. The determent device 312′ may be appropriately mounted within the vehicle 300 (e.g., within the engine).

The determent device 312′ may include a detection arrangement in the form of a sensor or transducer that can detect one or more operating states of the vehicle 300. For instance, the sensor may detect an electrical signal such as ignition voltage, an engine speed, and/or a transmission position (e.g., drive v. park). The determent device 312′ may also include any appropriate componentry to allow direct communication with a mobile device 308 in one or more of the seating areas 303 upon one or more of the operating states being detected. For example, upon an ignition voltage being detected, the determent device 312′ may be operable to communicate with a mobile device 308 in the driver's seating area 303 (e.g., via cellular protocol) to at least partially limit functionality of the mobile device 308 (e.g., switch the mobile device 308 into “driving mode”). For example, the determent device 312′ may send an enabling signal that causes the transmission of a wireless signal to a cutoff circuit in the mobile device 308.

In one arrangement upon a vehicle operating state being detected, call making capability of the mobile device 308 may be disabled and any incoming calls may be refused and automatically forwarded to one or more voice mail systems. To address the situation where an incoming caller does not leave a voice or other message, the mobile device 308 holder may periodically pull over, turn off the automobile or otherwise adjust the operating state (e.g., shift the transmission setting to “park”), and call back or otherwise communicate with any people or devices that may be likely to be attempting a communication with the mobile device 308 holder (e.g., wife, dispatcher). In another arrangement, the user of the mobile device 308 (e.g., the driver) may be appropriately notified as to the identity of the person or device responsible for the incoming communication. In this regard, the user may assess the urgency or importance of the incoming communication to determine whether to cease the detected operating state (e.g., pull over and turn off the vehicle 300) and review and/or return a call or communication. For instance, a screen of the mobile device 308 may indicate the identity of a caller or the mobile device 308 may audibly emit the identity of the caller (e.g., a caller may be prompted to identify himself or herself). Alternatively, one or more portions of the mobile device 308 may appropriately change color (e.g., glow) to indicate that a call or communication has been attempted and/or received. In some arrangements, the notification may indicate whether the call or communication is of high priority or urgency in which case the driver should pull over, turn off the car and listen to or read the message. In other arrangements, voice, text and/or internet communications may be received and listened to/read while the automobile is being operated to allow the driver or other mobile device user to determine whether it is necessary to pull the automobile over, turn off the automobile and engage in mobile devices transmissions (e.g., return the call or text message, send an email).

It should be appreciated that any appropriate logic may be associated with and/or resident within the mobile device 308 and/or other computing device (e.g., server) associated with the mobile device network to cause the mobile device 308 to provide notification to the user of the identity of the caller and/or other device responsible for the communication upon the operating state being detected. Another embodiment envisions that the determent device 312′ may be in the form of an “acoustic jammer” that includes a housing with componentry to detect an operating state of the vehicle in addition to componentry that can, upon the detection of the operating state of the vehicle, transmit a scrambling signal to disable mobile device usage and/or emit sounds or tones to make mobile device usage overly burdensome.

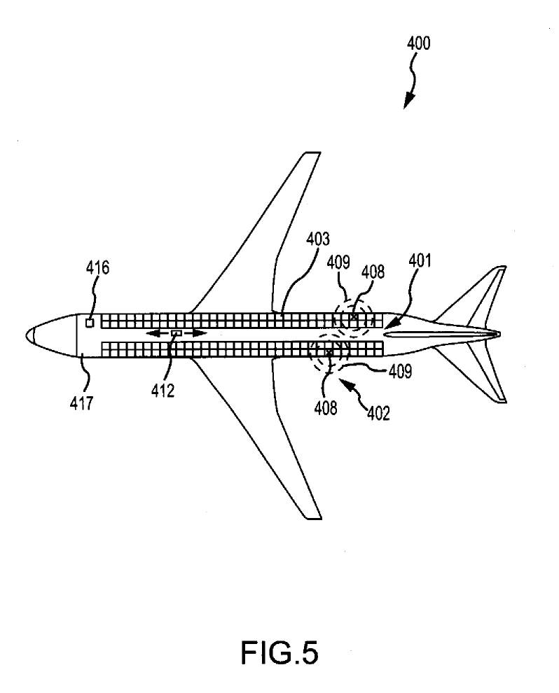

FIG. 5 illustrates a schematic diagram of an aircraft 400 including a mobile device functionality limiting system 402 according to another embodiment. The aircraft 400 generally includes a cabin 401 including a number of seating areas 403 and the system 402 for limiting functionality of one or more mobile devices 408 in one or more of the seating areas 403. As illustrated, one or more of the mobile devices 408 may emit RF transmission signals 409. As will be discussed below, the system 402 may include a number of arrangements and/or devices to limit mobile device 408 functionality within the cabin 401.

The system 402 may include a detection arrangement 412 in the form of a compact or hand-held device that may be operable to detect RF signal transmissions. For instance and after the aircraft passengers have been told or otherwise signaled to cease use of mobile devices 408 (e.g., once the aircraft 400 has started taxing before takeoff), any appropriate personnel (e.g., flight attendant) may operate the detection arrangement 412 (e.g., at high sensitivity) at random times or according to any appropriate schedule to check for any RF transmissions. Upon detection of illicit mobile device 408 activity, the personnel may walk through the cabin 402 with the detection arrangement 412 (e.g., at low sensitivity) to locate any offending mobile devices 408. The detection arrangement 412 may include a silent alarm (e.g., flashing indicator, vibration) associated therewith that increases in intensity as the detection arrangement 412 approaches an offending mobile device 408. Such mobile devices 408 may be confiscated until the conclusion of the flight and/or other corrective action may be taken (e.g., identifying an operator of the mobile device for later corrective action). In one variation, the detection arrangement 412 may also include a disabling arrangement, and in this regard, may resemble the above-described “acoustic jammer”. The acoustic jammer may be operable to both detect offending mobile devices 408 and also at least partially disable such mobile devices 408 (e.g., via an interfering signal). It will be appreciated that the personnel may be required to “home in” on potential offending devices after picking up faint RF signals with the detection arrangement 412. In another variation, a detection arrangement may be permanently located in a portion of the aircraft 400 to detect RF signals. Upon detection of RF signals, the hand-held arrangement 412 may be used to locate offending mobile devices 408.

The system 402 may also include a disabling arrangement 416 in the form of a signal transmission device that may be permanently located in any appropriate portion of the aircraft 400 (e.g., in the galley 417, in the cockpit). The disabling arrangement 416 may be operable to emit RF signals (e.g., see above discussion) at frequencies that interfere with those used by mobile devices 408. Additionally or alternatively, the disabling arrangement 416 may be operable to send signals to one or more of the mobile devices 408 that activate any appropriate disabling devices resident within the mobile devices 408 (e.g., the above noted “cutoff circuit”) and/or switch the mobile devices 408 into an “airplane mode”. For instance, the disabling arrangement 416 may transmit such signals either automatically (e.g., when mobile device 408 use restrictions are in place) or manually by way of any appropriate personnel. In other arrangements, the disabling arrangement 416 may be operable to at least partially disable individual mobile devices 408 by way of transmitting any appropriate signal to such individual mobile devices 408 (e.g., that is associated with calling such individual mobile devices 408). For example, a member of the flight crew may use any appropriate device (e.g., a mobile device) to appropriately communicate with one or more mobile devices 408 on-board to switch such mobile devices 408 into an “airplane mode”. It will be appreciated that any appropriate hardware and/or software associated with the mobile devices 408 and/or other computing devices (e.g., one or more servers associated with the mobile device network) may be operable to cause the mobile devices 408 to be limited in functionality upon the flight crew calling or otherwise communicating with on-board mobile devices 408. After any of the above disabling or corrective actions have been taken, personnel may again operate the detection arrangement 412 to determine that the corrective action has been effective in terminating further transmission from the mobile device(s). It will be appreciated that any of all of the above discussion may be equally applicable to other environments such as prison cells, casinos, etc.

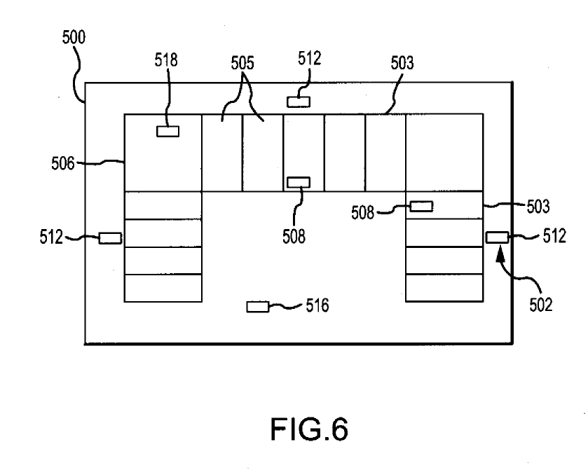

FIG. 6 illustrates a schematic diagram of a prison 500 including a mobile device functionality limiting system 502 according to another embodiment. The prison 500 generally includes one or more cell blocks 503 and each of the cell blocks 503 includes a number of cells 505. One or more of the cell blocks 503 may include a cell block office 506 accessible to prison guards and other prison personnel. As will be discussed below, the system 502 may include a number of arrangements and devices to limit functionality of mobile devices 508 (e.g., bootleg cell phones) over an area such as within one or more of the cell blocks 503.

One or more of the cell blocks 503 may be equipped with a determent device 512 (e.g., the determent device 312) that may be operable to both detect mobile device transmission signals (e.g., RF signals) within a defined area (e.g., the cell particular cell block 503 that the determent device 512 is mounted within) and thereafter disable usage of one or more mobile devices 508. For instance, each determent device 512 may include one or more of the above-discussed disabling arrangements (e.g., sound emitter, scrambling and/or jamming device) to limit mobile device 508 functionality. Each determent device 512 may be appropriately located in any substantially inaccessible location (except to service technicians and other prison personnel) and in other embodiments, may limit mobile device 508 functionality over an area greater than a single cell block (e.g., several cell blocks).

In one arrangement, a prison guard or other personnel (not shown) may have access to a silent alarm detector 516 (e.g., the above-described detection arrangement 412) and can move through the prison 500 to locate offending mobile devices 508. Further, one or more of the cell block offices 506 may have one or more silent detectors 518 each including any appropriate combination of hardware and/or software that is operable to detect that a mobile device 508 is being inappropriately operated and provide an indication (e.g., flashing light, pop message on a computing device, text message) of such illicit usage. Upon a silent detector 518 indicating that a mobile device 508 is being illicitly used, a guard or other personnel may move across the corresponding cell block 503 with a silent alarm detector 516 to locate offending mobile devices 508. Although not shown, one or more jamming or scrambling mechanisms or devices may be associated with the individual cells 505 of inmates who have engaged in repeated illicit mobile device 508 usage. This jamming or scrambling device may include any appropriate RF transmitter or transceiver to report its location to the cell block office 506 or other central prison office. Other devices or combinations of the above devices are also contemplated as being within the scope of the embodiments.

Other environments are also envisioned within which to limit mobile device functionality using one or more of the arrangements and devices disclosed herein. For instance, a determent device (e.g., the determent device 312) may be appropriately associated with the driver's seating area in a limousine or taxi to prevent the driver from successfully utilizing a mobile device within the driver's seating area. Passengers, who typically reside behind the driver and may be separated from the driver by any appropriate dividing panel, may have their own mobile device antennas and may use their mobile devices in a conventional manner. Similar determent devices may be used in other environments such as small trucks or trucks with sleeping lofts.

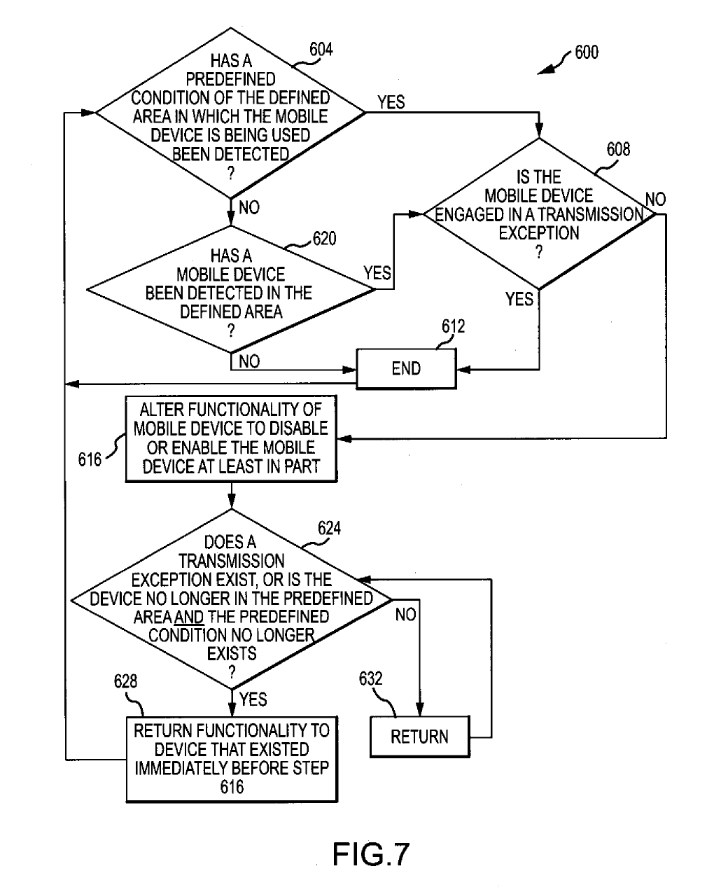

FIG. 7 illustrates a block diagram of a protocol or method 600 of limiting mobile device functionality using any of the embodiments and arrangements disclosed herein. In step 604, the method may question whether a predefined condition of the defined area in which the mobile device is being used has been detected. For instance, the predefined condition may include an operating state of an automobile (e.g., detected ignition voltage or speed), a switch or signal initiated automatically or manually by aircraft personnel, etc. If the answer to step 604 is yes, the method may proceed to step 608 whereby the method questions whether the mobile device is engaged in a “transmission exception.” Representative exceptions may include emergency calls (e.g., 911), network overhead, and the like. If the answer to step 608 is yes, the method may end at step 612 and then may return to step 604. If the answer to step 608 is no, the method may proceed to step 616 which will be discussed below. However, if the answer to step 604 is no, then the method may question whether a mobile device has been detected in the defined area in step 620. As discussed previously, a mobile device can be determined to be in the defined area 620 using any appropriate devices (e.g., a detection arrangement 212). Similar to the results of step 604, if the answer to step 620 is yes, the method may proceed to step 608 and if the answer to step 620 is no, the method may proceed to step 612.

In step 616, the method may include altering functionality of the mobile device to at least partially disable or enable the mobile device. For example, RF transmissions from the mobile device may be disabled or at least limited. Thereafter, in step 624, the method may question whether a transmission exception exists or whether the device is no longer in the defined area and the predefined condition no longer exists. If a transmission exception exists (e.g., the mobile device user attempts to call 911) or if the mobile device is not in the predefined area (e.g., automobile cabin) and the predefined condition no longer exists (e.g., the automobile is in park instead of drive), the method may move to step 628 whereby the functionality that existed in the mobile device immediately before step 616 is returned to the mobile device, and then the method may move back to step 604. However, if the answer to step 624 is no, then the method may move to step 632 whereby the method may return to step 624. It should be appreciated that the above described method 600 is only representative and that numerous other methods of practicing the embodiments and arrangements disclosed herein are also contemplated.

It will be appreciated that one or more of the components and devices described herein may be in the form of any appropriate computing device including any appropriate type and quantity of computer memory (e.g., RAM) for storing data and instructions and processors (e.g., central processing unit) for executing such instructions and processing data. Such processors may retrieve instructions and other data from any appropriate storage device (e.g., hard drive) before loading such instructions and other data into the computer memory. The processors, computer memory, and storage device(s) may be connected by a bus in a conventional manner.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. For instance, the various methods and devices described herein may be incorporated into any appropriate controller (e.g., a mobile device controller), vehicle (e.g., automobile, truck, airplane) and/or structure to reduce mobile device usage while operating such vehicles or interacting in a particular environment.

The embodiments described hereinabove are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

What is claimed:

1. An apparatus for use in reducing mobile device usage within one or more defined environments, comprising:
detection structure for detecting at least one of a presence of one or more mobile devices in the one or more defined environments and a condition related to an operating state associated with the one or more defined environments; and
interference structure for acoustically interfering with operation of a mobile device in the defined area in response to the detected presence or condition.

2. The apparatus as set forth in claim 1, wherein the detection structure comprises circuitry for use in detecting an electrical signal associated with a starting operation of a machine.

3. The apparatus as set forth in claim 2, wherein the machine is a motor vehicle.

4. The apparatus as set forth in claim 1, wherein said detection structure comprises circuitry for detecting a setting of a transmission of a motor vehicle.

5. The apparatus as set forth in claim 1, wherein the detection structure comprises circuitry for detecting a restricted use condition associated with the one or more defined environments.

6. The apparatus as set forth in claim 5, wherein the one or more defined environments are at least partially associated with at least one of a motor vehicle, an aircraft, and a prison block.

7. The apparatus as set forth in claim 1, wherein the detection structure comprises componentry for detecting that one or more mobile devices are transmitting or receiving transmissions in the one or more defined environments.

8. The apparatus as set forth in claim 7, wherein the transmissions comprise RF signals.

9. The apparatus as set forth in claim 7, wherein the componentry includes at least one band-pass filter that is operable to pass the transmissions through a demodulator.

10. The apparatus as set forth in claim 1, wherein the interference structure comprises a sound transmitter for transmitting sounds that inhibit use of one or more mobile devices in the one or more defined environments.

11. The apparatus as set forth in claim 10, wherein the sounds comprise at least one of white noise and human speech.

12. The apparatus as set forth in claim 10, wherein the sounds comprise a sound level peak higher than a sound level peak of transmissions associated with the one or more mobile devices.

13. The apparatus as set forth in claim 1, wherein the interference structure comprises a scrambling device operable to generate scrambling transmissions, wherein the scrambling transmissions operate at frequencies similar to frequencies used by transmissions associated with the one or more mobile devices.

14. A method for use in reducing mobile device functionality in one or more defined environments, comprising the steps of:
detecting at least one of a condition related to an operating state associated with the one or more defined environments and the presence of one or more mobile devices in the one or more defined environments; and
in response to the detected condition, acoustically interfering with the operation of the one or more mobile devices in the one or more defined environments.

15. The apparatus as set forth in claim 14, wherein the condition is a restricted use condition associated with the one or more defined environments.

16. The apparatus as set forth in claim 15, wherein the one or more defined environments are at least partially associated with at least one of a motor vehicle, an aircraft, and a prison block.

17. The method as set forth in claim 15, wherein the restricted use condition is detected based on receipt of a transmitted signal.

18. The method as set forth in claim 14, wherein the condition is associated with a motor vehicle.

19. The method as set forth in claim 18, wherein the step of detecting comprises detecting a signal associated with at least one of ignition, a starting operation, and a transmission setting of the motor vehicle.

20. The method as set forth in claim 18, further comprising:
transmitting, from the motor vehicle, a signal indicating the condition of the operating state, wherein the step of detecting comprises detecting the transmitted signal.

21. The method as set forth in claim 14, wherein the one or more defined environments comprises at least one of a portion of a motor vehicle, aircraft or prison block.

22. The method as set forth in claim 14, wherein the step of detecting comprises determining whether one or more mobile devices are transmitting or receiving transmissions in the one or more defined environments.

23. The method as set forth in claim 22, wherein the transmissions comprise RF signals.

24. The method as set forth in claim 22, wherein the step of determining comprises using at least one band-pass filter to pass the transmissions.

25. The method as set forth in claim 14, wherein the step of acoustically interfering comprises emitting sounds that are operable to inhibit use of one or more mobile devices in the one or more defined environments.

26. The method as set forth in claim 25, wherein the sounds comprise at least one of white noise and human speech.

27. The method as set forth in claim 25, wherein the sounds comprise a sound level peak higher than a sound level peak of transmissions associated with the one or more mobile devices.

28. The method as set forth in claim 14, wherein the step of acoustically interfering comprises generating scrambling transmissions that are operable to scramble transmissions associated with the one or more mobile devices.

29. The method as set forth in claim 28, wherein the scrambling transmissions operate at frequencies similar to frequencies used by the transmissions associated with the one or more mobile devices.

30. A motor vehicle comprising:
a first structure for sensing an operating state of the motor vehicle; and
a second structure for at least partially acoustically interfering with use of one or more mobile devices based on the sensed operating state.

31. The motor vehicle as set forth in claim 30, wherein the one or more mobile devices are located in a cabin of the motor vehicle.

32. The motor vehicle as set forth in claim 31, wherein the one or more mobile devices are located in a driver's area of the motor vehicle.
